(19) United States
(12) Patent Application Publication
(10) Pub. No.: US 2020/0355851 A1
(43) Pub. Date: Nov. 12, 2020

(54) PROTECTIVE FILM AND METHOD OF FABRICATING DISPLAY MODULE USING THE SAME

(71) Applicant: Samsung Display Co., LTD., Yongin-si (KR)

(72) Inventors: Dong-su YEE, Cheonan-si (KR); Sujin JUNG, Seoul (KR)

(21) Appl. No.: 16/848,321

(22) Filed: Apr. 14, 2020

(30) Foreign Application Priority Data
May 10, 2019 (KR) 10-2019-0054683

(51) Int. Cl. G02B 1/14; B32B 7/12; B32B 27/36; B32B 15/09

(52) U.S. Cl. CPC G02B 1/14; B32B 7/12; B32B 2457/20; B32B 15/09; B32B 27/36

(57) ABSTRACT

A protective film includes a film layer removably attachable to a display module; and a film adhesive layer which removably attaches the film layer to the display module. The film layer includes a first region having a shape corresponding to less than a total shape of the display module, the first region including a second portion extending from the first portion, and having a second width along a first direction, and a third portion extending from the second portion and having a third width along the first direction which is greater than the second width. Detachment of the film layer from the display panel includes the third portion detached after the second portion, and the third portion includes a plurality of first cuts extended into a thickness of the film layer.

This application claims priority to Korean Patent Application No. 10-2019-0054683 filed on May 10, 2019 in the Korean Intellectual Property Office, and all the benefits accruing therefrom under 35 U.S.C. § 119, the entire contents of which are hereby incorporated by reference.

### BACKGROUND

### (1) Field

The invention relates to a protective film attached to a heat radiation layer and a method of fabricating a display device using the protective film. More particularly, the invention relates to a protective film having a structure that reduces or effectively prevents damage to the heat radiation layer when the protective film is partially detached from the heat radiation layer.

### (2) Description of the Related Art

There have been developed display devices such as smart phones, tablet computers, and laptop computers. The display device includes a display module including a window, a display panel, and other components required for externally displaying an image. The components of the display module are individually manufactured, and then an assembly process is employed to organically arrange the components into a single display module.

### SUMMARY

One or more embodiment of the invention provides a protective film defined with cutting lines each having a shape that reduced or effectively prevent damages to a layer (e.g., a heat radiation layer) to which the protective film is attached, in a process in which a portion of the protective film attached to the heat radiation layer is removed.

One or more embodiment of the invention provides a method of fabricating a display module, which method uses the protective film defined with the cutting lines each having the shape to reduce or effectively prevent damages to a layer (e.g., a heat radiation layer) from which the protective film is removed.

According to an embodiment of the invention, a protective film includes a film layer which is removably attachable to a display module, and a film adhesive layer which removably attaches the film layer to the display module. The film layer includes a first region having a shape corresponding to less than a total shape of the display module, the first region including a first portion extending along a first direction and having a first width along a second direction crossing the first direction, a second portion extending along the second direction, from the first portion, and having a second width along the first direction, and a third portion extending along the second direction, from the second portion having the second width, and having a third width along the first direction which is greater than the second width. Detachment of the film layer from the display module includes the third portion detached after the second portion. The third portion which has the third width greater than the second width and is detached after the second portion includes a plurality of first cuts extended into a partial thickness of the film layer.

In an embodiment, at least one of the plurality of first cuts may include: a first segment having a first curvature; a second segment having a second curvature; and a third segment which is linear and connects the first segment to the second segment.

In an embodiment, the plurality of first cuts may be inclined with respect to the first direction.

In an embodiment, the first width may be greater than the second width.

In an embodiment, the film layer may further include a second region having a shape corresponding to a shape of the display module excluding the shape of the first region. The second region may include a plurality of sub-regions separable from each other. The plurality of sub-regions may include a first sub-region and a second sub-region spaced apart from each other and corresponding to opposing outer edges of the display module, and a third sub-region between the first sub-region and the second sub-region.

In an embodiment, the third sub-region may include a plurality of second cuts.

In an embodiment, the film layer may include polyethylene terephthalate (“PET”).

In an embodiment, the film adhesive layer may include silicon.

In an embodiment, a thickness of the film layer may be in a range between about 54 micrometers (μm) and about 72 μm.

In an embodiment, a thickness of the film adhesive layer may be in a range between about 5 μm and about 8 μm.

In an embodiment, the first region may further include a protrusion extending in the first direction from the first portion.

According to an embodiment, a protective film may include a film layer which is removably attachable to a display module, and a film adhesive layer which removably attaches the film layer to the display module. The film layer includes a first region having a shape corresponding to less than a total shape of the display module, the first region including a first portion extending along a first direction and having a first width along a second direction crossing the first direction, a second portion extending along the second direction, from the first portion, and having a second width along the first direction, and a third portion extending along the second direction, from the second portion having the second width, and having a third width along the first direction which is greater than the second width. Detachment of the film layer from the display module includes the third portion detached after the second portion. The third portion which has the third width greater than the second width and is detached after the second portion includes a plurality of openings extended through a thickness of the film layer.

In an embodiment, at least one of the plurality of openings may have a rectangular shape. At least one of the plurality of openings may be form an obtuse angle with respect to the first direction.

In an embodiment, the first width may be greater than the second width.

In an embodiment, the film layer further includes a second region having a shape corresponding to a shape of the display module excluding the shape of the first region. The second region may include a plurality of sub-regions separable from each other. The plurality of sub-regions may include a first sub-region and a second sub-region spaced apart from each other and corresponding to opposing outer edges of the display module, and a third sub-region between the first sub-region and the second sub-region, the third sub-region between the first sub-region and the second sub-region including a plurality of cuts extended into the thickness of the film layer.

In an embodiment, the film layer may include polyethylene terephthalate (“PET”). A thickness of the film layer may be in a range between about 54 μm and about 72 μm.

In an embodiment, the film adhesive layer may include silicon. A thickness of the film adhesive layer may be in a range between about 5 μm and about 8 μm.

According an embodiment, a method of providing a display module may include providing the display module including a display panel, a heat radiation layer defining a rear surface of the display module, and a flexible printed circuit board connected to the display panel and disposable adjacent to the rear surface of the display module, providing a protective film removably attached to the heat radiation layer, the protective film including a first region having a shape corresponding to a shape of the flexible printed circuit board, where the first region includes a second portion having a second width along a first direction, and a third portion extending along a second direction which crosses the first direction, from the second portion having the second width, the third portion having a third width along the first direction which is greater than the second width, and sequentially detaching the second portion and the third portion of the protective film from the heat radiation layer. The third portion of the protective film which has the third width greater than the second width and is sequentially detached from the heat radiation layer after the second portion includes a plurality of first cuts extended into a thickness of the protective film.

In an embodiment, at least one of the plurality of cuts may include a first segment having a first curvature; a second segment having a second curvature; and a third segment which connects the first segment to the cutting segment.

In an embodiment, the protective film further includes a second region having a shape corresponding to a shape of the display module excluding the shape of the flexible printed circuit board. The second region may include a plurality of sub-regions separable from each other. The plurality of sub-regions may include a first sub-region and a second sub-region spaced apart from each other and corresponding to opposing outer edges of the display module, a third sub-region between the first sub-region and the second sub-region.

### BRIEF DESCRIPTION OF THE DRAWINGS

The above and other advantages and features of this disclosure will become more apparent by describing in further detail embodiments thereof with reference to the accompanying drawings, in which:

FIG. 1 illustrates a top plan view of an embodiment of a display module.

FIGS. 2A and 2B illustrate enlarged cross-sectional views taken along line I-I′ of FIG. 1.

FIG. 3 illustrates a top plan view of an embodiment of a protective film depicted in FIG. 2A.

FIG. 4 illustrates an enlarged top plan view of an embodiment of section AA of FIG. 3.

FIG. 5 illustrates an enlarged top plan view of a modified embodiment of section AA depicted in FIG. 3.

FIG. 6 illustrates a top plan view of another embodiment of a protective film.

FIG. 7 illustrates a top plan view of still another embodiment of a protective film.

FIG. 8A illustrates a top plan view of yet another embodiment of a protective film.

FIG. 8B illustrates an enlarged top plan view of section BB of FIG. 8A.

FIG. 9 illustrates a plan view showing an embodiment of a process or removing a protective film in a method of providing a display module.

### DETAILED DESCRIPTION

The following will now describe embodiments of the invention in conjunction with the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

In the drawings, thicknesses of layers and regions are exaggerated for effectively explaining the technical contents. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” The term “and/or” includes one or more combinations defined by associated components.

It should be understood that the terms “comprise,” “include,” “have” and the like are used to specify the presence of stated features, integers, steps, operations, components, elements, or combinations thereof, but do not preclude the presence or addition of one or more other features, integers, steps, operations, components, elements, or combinations thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A first direction DR1 is defined to refer to an arbitrary direction, a second direction DR2 is defined to refer to a direction crossing the first direction DR1, and a third direction DR3 is defined to refer to a direction crossing each of the first and second directions DR1 and DR2. In an embodiment, the first, second and third directions DR1, DR2 and DR3 may be perpendicular to each other, without being limited thereto. The third direction DR3 may be referred to as a thickness direction, without being limited thereto.

In manufacturing a display device, at least a portion of one or more of the components of a display module may be covered with a protective film to reduce or effectively prevent damage thereto during transportation or storage of such components before assembling the component into the display module. When a portion of the protective film is subsequently detached to assemble the components, a problem occurs in which a certain component is undesirably detached together with the protective film attached thereto.

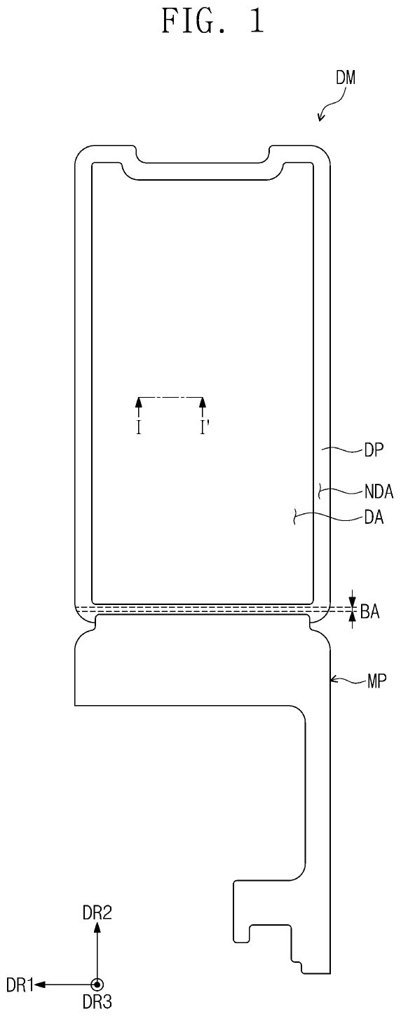

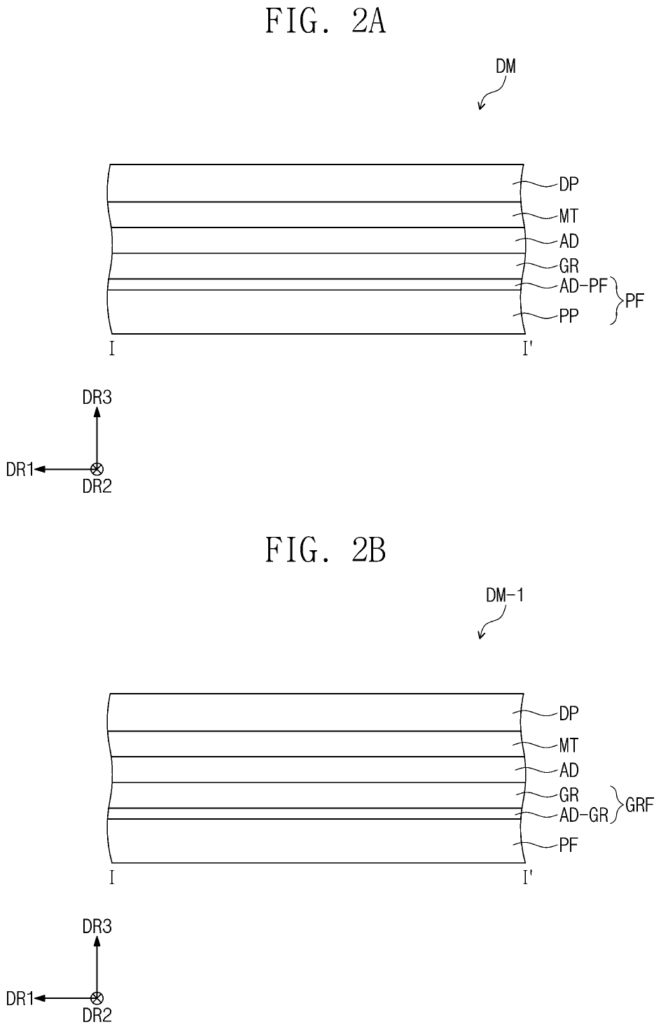

FIG. 1 is a top plan view of an embodiment of a display module DM. FIGS. 2A and 2B are enlarged cross-sectional views of embodiments of the display module DM, taken along line I-I′ of FIG. 1. The display module DM may be a component of a display device, without being limited thereto.

Referring to FIG. 1, a display area DA and a non-display area NDA may be defined at a front surface of the display module DM. An image may be displayed at the display area DA. An image may not be displayed at the non-display area NDA. The non-display area NDA may be known as a bezel region of the display module DM. The image display at the display area DA may be visible from outside the display module DM. The display device may include a display area DA, a non-display area NDA, a bezel region, etc. which respectively corresponds to those features of the display module DM.

Referring to FIGS. 1, 2A, and 2B, the display module DM and a modified embodiment thereof as the display module DM-1 may variously include a display panel DP, a rigid support member such as a metal plate MT, a fixing member such as an adhesive layer AD, a heat radiation member such as a heat radiation layer GR, a protective member such as a protective film PF, and a flexible printed circuit board MP. The invention is not limited thereto.

The display panel DP may generate an image. The display panel DP may be a liquid crystal display (“LCD”) panel, an organic light emitting display panel, a quantum-dot light emitting display panel, or a panel including a micro-LED (micro-light emitting diode).

The display panel DP may include or define a bending area BA at which the display module DM, the display panel DP and/or various components thereof, may be bendable about a bending axis. The bending of the bending area BA may dispose the flexible printed circuit board MP facing or adjacent to a rear surface of the display module DM which opposite to the front surface thereof along the third direction DR3.

The metal plate MT may be disposed below the display panel DP. The metal plate MT may support the display panel DP, and may transfer heat to the heat radiation layer GR from the display panel DP. The metal plate MT may include stainless steel.

The adhesive layer AD may be disposed below the metal plate MT. The adhesive layer AD may attach the metal plate MT to the heat radiation layer GR. The adhesive layer AD may include a pressure sensitive adhesive (“PSA”).

In an embodiment, the adhesive layer AD may have a thickness of about 32 micrometers (μm). The thickness of the adhesive layer AD is a length or distance measured along the third direction DR3 of the adhesive layer AD.

The heat radiation layer GR may be disposed below the adhesive layer AD. The heat radiation layer GR may radiate heat transferred thereto from the metal plate MT, and may reduce or effectively prevent heating of the display module DM. The heat radiation layer GR may include a graphite sheet. The heat radiation layer GR may define a rear surface of the display module DM. The bending of the bending area BA may dispose the flexible printed circuit board MP facing the heat radiation layer GR.

In an embodiment, the heat radiation layer GR may have a thickness of about 32 μm. The thickness of the heat radiation layer GR is a length or distance measured along the third direction DR3 of the heat radiation layer GR.

Impact occurring at the protective film PF may be transmitted to an entirety of the heat radiation layer GR. In an embodiment, for example, impact occurring at the protective film PF may damage the heat radiation layer GR.

The protective film PF may be disposed below the heat radiation layer GR. The protective film PF may reduce or effectively prevent damage to the heat radiation layer GR in fabricating the display module DM, such as during transport or storage of a component including the heat radiation layer GR. In an embodiment, for example, the protective film PF may be attached to a bottom of the heat radiation layer GR, and may protect the heat radiation layer GR against moisture or foreign substances produced in fabricating the display module DM.

As shown in FIG. 2A, the protective film PF may include a film fixing member such as a film adhesive layer AD-PF, and a film layer PP. The film adhesive layer AD-PF may be disposed between the heat radiation layer GR and the film layer PP. The film adhesive layer AD-PF may couple the heat radiation layer GR to the film layer PP. The film adhesive layer AD-PF may include silicon (e.g., a silicon-based material).

In an embodiment, the film adhesive layer AD-PF may have an adhesive force between about 3 grams-force per inch (gf/inch) and about 8 gf/inch.

In an embodiment, the film adhesive layer AD-PF may have a thickness (also called a first thickness) ranging from about 5 μm to about 8 μm. The thickness of the film adhesive layer AD-PF is a length or distance measured along the third direction DR3 of the film adhesive layer AD-PF.

When the first thickness is less than 5 μm, the film adhesive layer AD-PF may not have sufficient adhesive force. When the first thickness is greater than 8 μm, removing the film layer PP may be difficult, and residue of the film adhesive layer AD-PF may remain on the display module DM after the removal of the film layer PP.

The film layer PP according to one or more embodiment may be disposed below the film adhesive layer AD-PF. The film layer PP may include polyethylene terephthalate (“PET”).

In an embodiment, the film layer PP may have a thickness (also called a second thickness) ranging from about 54 μm to about 72 μm. The thickness of the film layer PP is a length or distance measured along the third direction DR3 of the film layer PP.

When the second thickness less than 54 μm, durability of the film layer PP may decrease and the heat radiation layer GR may be insufficiently protected from external impact. When the second thickness is greater than 72 μm, product cost may increase, and strength of the film layer PP may be so high that the heat radiation layer GR may be damaged during attachment of the protective film PF thereto.

As shown in FIG. 2B, a display module DM-1 may include a heat radiation function layer GRF. In an embodiment, for example, the heat radiation function layer GRF may include a heat radiation layer GR and a fixing member such as a heat radiation adhesive layer AD-GR. The heat radiation adhesive layer AD-GR may include a black ink and a pressure sensitive adhesive (“PSA”).

The heat radiation adhesive layer AD-GR may be merely an example of the film adhesive layer AD-PF. In an embodiment, for example, the heat radiation adhesive layer AD-GR may have a function substantially the same as that of the film adhesive layer AD-PF.

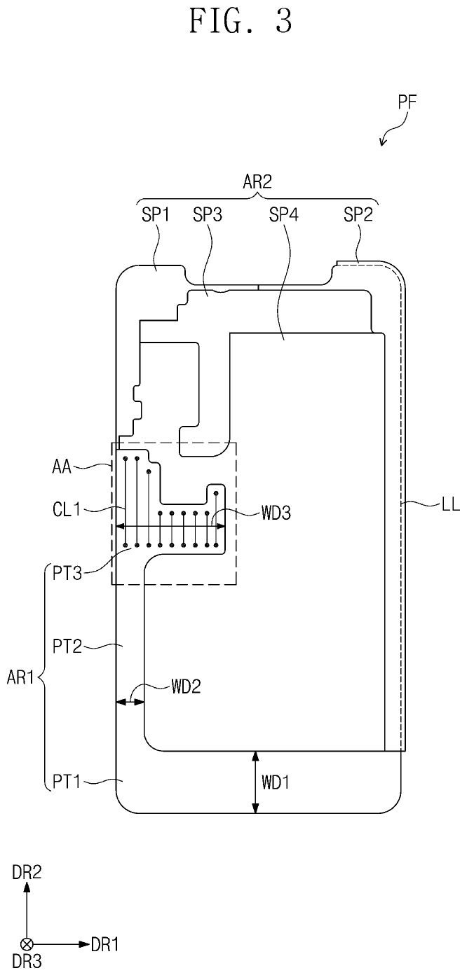

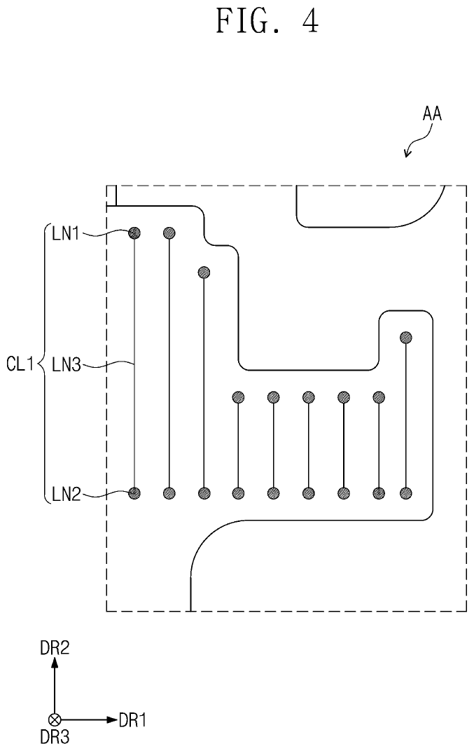

FIG. 3 is a top plan view of an embodiment of the protective film PF depicted in FIG. 2A. FIG. 4 is an enlarged plan view of section AA of FIG. 3.

Referring to FIG. 3, the protective film PF may have a first region AR1 and a second region AR2. An externally applied force to the protective film PF may separate the first region AR1 and the second region AR2 from each other.

The first region AR1 may include a first portion PT1, a second portion PT2, and a third portion PT3. Planar areas of the first portion PT1, the second portion PT2, and the third portion PT3 may be removably attachable to corresponding planar areas of the display module DM at a rear surface thereof. A shape of the first region AR1 may be less than a total shape of the display module DM.

The first portion PT1 may lengthwise extend along the first direction DR1. The first portion PT1 has or defines a first width WD1. The first width WD1 is a length or distance measured along the second direction DR2 of the first portion PT1.

The second portion PT2 may lengthwise extend along the second direction DR2 from the first portion PT1 and toward the second region AR2. The second portion PT2 has or defines a second width WD2. The second width WD2 is a length or distance measured along the first direction DR1 of the second portion PT2. In an embodiment, the second width WD2 may be less than the first width WD1.

The third portion PT3 may lengthwise extend along the second direction DR2 from the second portion PT2. The third portion PT3 has or defines a third width WD3. The third width WD3 is a length or distance measured along the first direction DR1 of the third portion PT3. In an embodiment, the third width WD3 may be greater than the second width WD2.

A total shape of the first, second, and third portions PT1, PT2, and PT3 of the first region AR1 may correspond to a shape of the flexible printed circuit board MP. As used herein, “shape” may refer to a planar shape. Referring to FIGS. 1 and 3, for example, the total shape of the first, second, and third portions PT1, PT2, and PT3 and the shape of the flexible printed circuit board MP may be defined in a plane defined by the first direction DR1 and the second direction DR2 which cross each other.

The third portion PT3 may include or be defined with a first cutting line CL1 provided in plural (e.g., a plurality of first cutting lines CL1) each of which has a cut shape.

In an embodiment, the second region AR2 of the protective film PF includes a plurality of sub-regions SP1, SP2, SP3, and SP4 that are separable from each other. The second region AR2 is also separable from the first region AR1. The plurality of sub-regions SP1, SP2, SP3, and SP4 may include a first sub-region SP1, a second sub-region SP2, a third sub-region SP3, and a fourth sub-region SP4. Planar areas of the first sub-region SP1, the second sub-region SP2, the third sub-region SP3, and the fourth sub-region SP4 may be removably attachable to corresponding planar areas of the display module DM. A total shape of the first sub-region SP1, the second sub-region SP2, the third sub-region SP3, and the fourth sub-region SP4 of the second region AR2 may correspond to a remaining area of the display module DM except for the first region AR1, without being limited thereto.

The third sub-region SP3 and the fourth sub-region SP4 may each be disposed or connected between the first sub-region SP1 and the second sub-region SP2. The first sub-region SP1 and the second sub-region SP2 are respectively disposed corresponding to opposing outer edges (e.g., at the non-display area NDA) of the display module DM, while the third sub-region SP3 and the fourth sub-region SP4 are disposed spaced apart from the outer edges of the display module DM.

An externally applied force may separate the first, second, third, and fourth sub-regions SP1, SP2, SP3, and SP4 from each other.

The second sub-region SP2 may include a portion that does not correspond to the display module DM, such that removal of the second sub-region SP2 from the display module DM may be relatively easy in a process in which the second sub-region SP2 and the display module DM are separated from each other. A dotted line LL defined in the second sub-region SP2 exemplarily indicates a boundary between a portion of the second sub-region SP2 which does not correspond to the display module DM and another portion of the second sub-region SP2 which does correspond to the display module DM. Referring to FIG. 3, the dotted line LL may correspond to an outer edge of the display module DM. The portion of the second sub-region SP2 which does not correspond to the display module DM may define an outer edge of the protective film PF at the second sub-region SP thereof. The protective film PF attached to the display module DM disposes a portion of the second sub-region SP2 extended further than an edge of the display module DM which corresponds to the dotted line LL.

The first width WD1, the second width WD2 and the third width WD3 may be considered in representing a relative contact area of the first portion PT1, the second portion PT2, and the third portion PT3, respectively, with respect to the display module DM, without being limited thereto. A value of a contact area may be defined by a product of a width and length of a respective portion of the first region AR1.

When the protective film PF is removed from the heat radiation layer GR of the display module DM, the first, second, and third portions PT1, PT2, and PT3 removably attached to planar areas of the heat radiation layer GR are detached in the foregoing sequence.

When the first portion PT1 is detached and then the second portion PT2 is detached in order, a width of a contact area of the protective film PF is reduced from including the first width WD1 to including the second width WD2, and thus damage to the heat radiation layer GR is obviated since a relatively high stress is not applied to the protective film PF in removal thereof from the display module DM.

In contrast, when the second portion PT2 is detached and then the third portion PT3 is detached, a contact area indicated by a width of the protective film PF is increased from the second width WD2 to the third width WD3, and thus the protective film PF may be supplied with relatively high stress by which the protective film PF and the heat radiation layer GR to which the protective film PF is attached may be damaged.

To reduce or effectively prevent such damage to the protective film PF and/or the heat radiation layer GR, the plurality of first cutting lines CL1 are defined in or on the third portion PT3. That is, considering an order in which different planar areas of the protective film PF attached to the display module DM are arranged along the display module DM, or considering an order in which different planar areas of the protective film PF are removed from the display module DM, a penetration into the thickness of the protective film PF is provided at a portion of the protective film PF having a relatively larger planar area as compared to a preceding portion of the protective film PF having a relatively smaller planar area.

The plurality of first cutting lines CL1 may lengthwise extend parallel to the second direction DR2. However, the invention is not limited thereto, and the plurality of first cutting lines CL1 may lengthwise extend in a direction inclined relative to the first direction DR1 and/or the second direction DR2. In an embodiment, the plurality of first cutting lines CL1 may lengthwise extend inclined at a right angle or an acute angle with respect to the first direction DR1.

The cut shapes of the plurality of first cutting lines CL1 may minimize friction and/or contact area between the protective film PF and the heat radiation layer GR and also minimize rotational stress applied to the protective film PF. As such, damage to the heat radiation layer GR may be reduced or effectively prevented. As used herein, a “cut shape” indicates a location of the protective film PF at which a thickness of the protective film is penetrated from a front and/or rear surface of the protective film PF. Such “cut shape” may otherwise be referred to as a penetration, a thickness penetration or a cut which is defined extended into a thickness of the protective film PF. In an embodiment, the “cut shape” may be a groove, recess or score penetrating a partial thickness of the protective film PF, or an opening penetrating an entirety of the thickness of the protective film PF. A penetration of a partial thickness or an entire thickness of the protective film PF may have a dimension in a plan view. Referring to FIG. 4, for example, dimensions of a first cutting line CL1 and various segments thereof may have dimensions defined along a plane defined by the first direction DR1 and the second direction DR2 crossing each other.

Referring to FIG. 4, at least one of the plurality of first cutting lines CL1 may include a first cutting segment LN1 (e.g., first segment), a second cutting segment LN2 (e.g., a second segment), and a third cutting segment LN3 (e.g., a third segment). A single one first cutting line CL1 may be defined by the first cutting segment LN1, the second cutting segment LN2 and the third cutting segment LN3.

In an embodiment, the first cutting segment LN1 has a first curvature. The first cutting segment LN1 may have a circular groove shape as the cut shape. The second cutting segment LN2 has a second curvature. The second cutting segment LN2 may have a circular groove shape. The first cutting segment LN1 and the second cutting segment LN2 may be defined by a groove extended into the thickness of the protective film PF and having a planar shape of a circle.

The third cutting segment LN3 connects the first cutting segment LN1 to the second cutting segment LN2. The third cutting segment LN3 may be a linear segment as the cut shape. The third cutting segment LN3 may be defined by a groove extended into the thickness of the protective film PF and having a planar shape as a line. The third cutting segment LN3 which connects the first cutting segment LN1 to the second cutting segment LN2 may define the first cutting line CL1 as a single and continuous penetration into the thickness of the protective film PF.

An additional process may be required to provide or form the grooves of the first and second cutting segments LN1 and LN2, as compared to providing the linear shape third cutting segment LN3 having the smaller planar dimension than the first and second cutting segments LN1 and LN2, without being limited thereto.

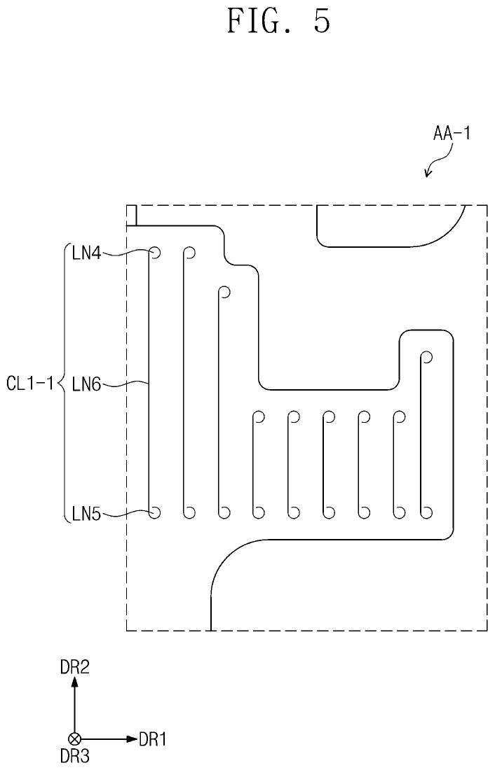

FIG. 5 is an enlarged plan view of another embodiment of section AA of FIG. 3.

Referring to a section AA-1 shown in FIG. 5, a modified cutting line CL1-1 is provided in plural (e.g., a plurality of modified cutting lines CL1-1) may be defined at the third portion PT3. At least one of the plurality of modified cutting lines CL1-1 may include a fourth cutting segment LN4 (e.g., fourth segment), a fifth cutting segment LN5 (e.g., a fifth segment), and a sixth cutting segment LN6 (e.g., a sixth segment).

In an embodiment, the fourth cutting segment LN4 has a fourth curvature. The fourth cutting segment LN4 may have a curved shape. The fifth cutting segment LN5 has a fifth curvature. The fifth cutting segment LN5 may have a curved shape. The fourth cutting segment LN4 and the fifth cutting segment LN5 may be defined by a groove or an opening extended into the thickness of the protective film PF and having a planar shape of a curved line at a distal end of the modified cutting line CL1-1.

The sixth cutting segment LN6 connects the fourth cutting segment LN4 to the fifth cutting segment LN5. The sixth cutting segment LN6 may be a linear segment. The sixth cutting segment LN6 may be defined by a groove or an opening extended into the thickness of the protective film PF and having a planar shape as a straight line. The sixth cutting segment LN6 which connects the fourth cutting segment LN4 to the fifth cutting segment LN5 may define the modified cutting line CL1-1 as a single and continuous penetration into the thickness of the protective film PF.

In the case of the embodiment shown in FIG. 5, a single process may be employed to form the fourth, fifth, and sixth cutting segments LN4, LN5, and LN6, since each segment has substantially a same line width along an entirety of the length of the modified cutting line CL1-1. Thus, it may be possible to increase promptness, accuracy, economy, and efficiency.

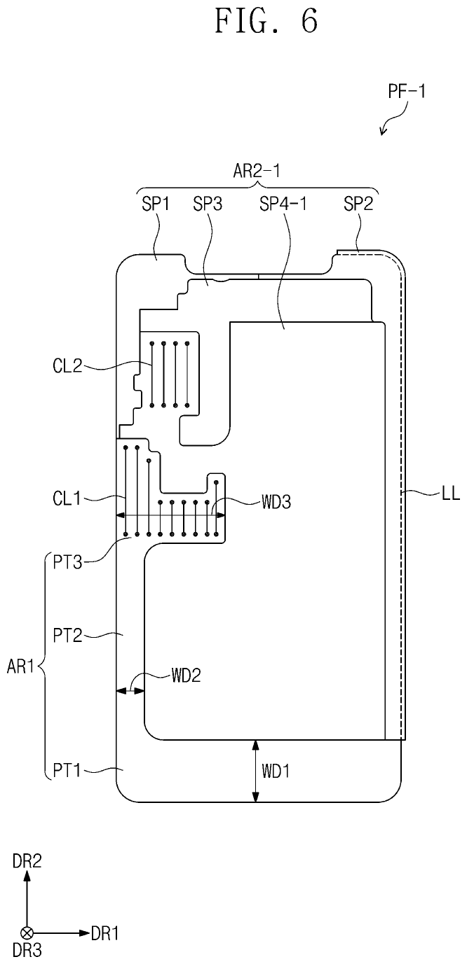

FIG. 6 is a top plan view of another embodiment of a protective film PF-1. In an embodiment, a second cutting line CL2 provided in plural (e.g., a plurality of second cutting lines CL2) may be defined at a fourth sub-region SP4-1 of a second region AR2-1.

A specific portion of the fourth sub-region SP4-1 may be designed such that a relatively small-width portion is detached and then a relatively large-width portion is detached, in order. In this case, the fourth sub-region SP4-1 may be defined with the plurality of second cutting lines CL2 to reduce or effectively prevent damage to the heat radiation layer GR corresponding to the fourth sub-region SP4-1 due to stress resulting from variations in film removal direction and film contact area.

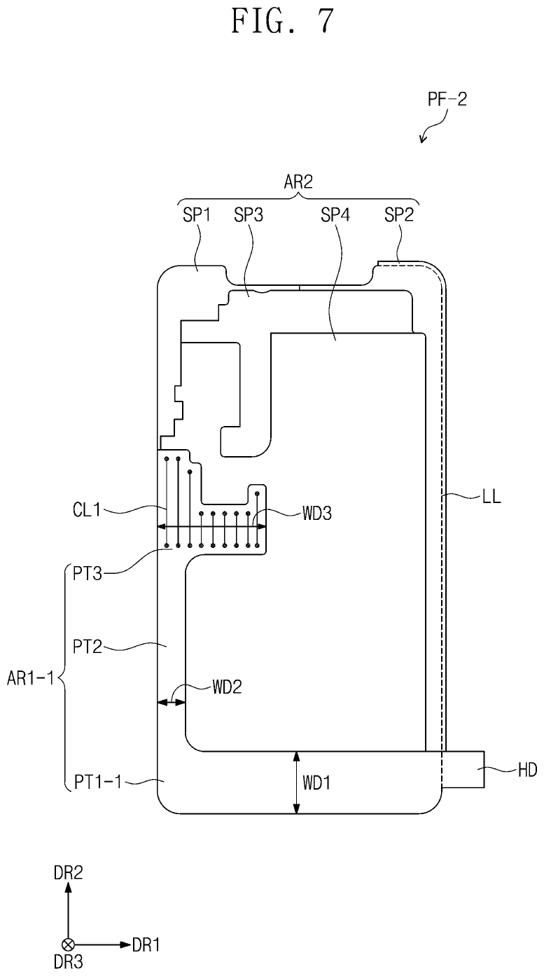

FIG. 7 is a top plan view of still another embodiment of a protective film PF-2.

A first region AR1-1 may further include a protrusion HD extending along the first direction DR1 from a first portion PT1-1. The protrusion HD may be grasped to sequentially detach the first portion PT1-1, the second portion PT2, and the third portion PT3 from the display module DM, which may result in removal of the protective film PF-2 at the first region AR1-1 thereof from the display module DM. The protective film PF-2 attached to the display module DM disposes the protrusion HD extended further than an edge of the display module DM which corresponds to the dotted line LL.

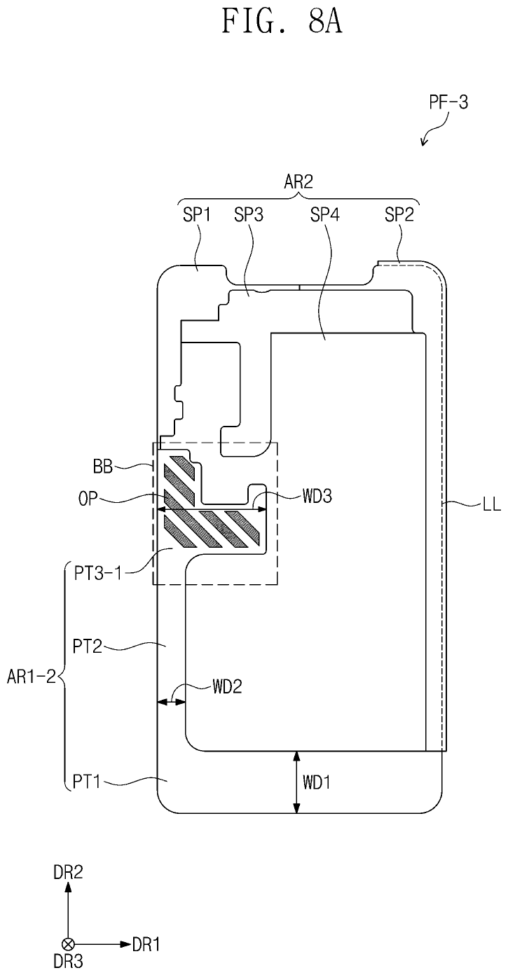

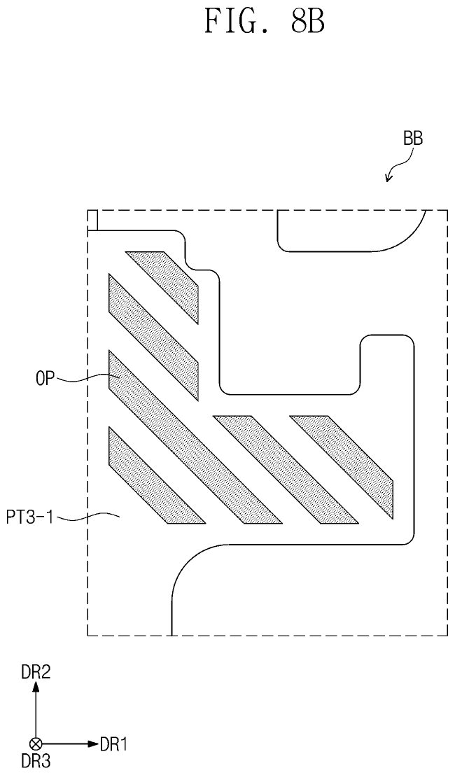

FIG. 8A is a top plan view of yet another embodiment of a protective film PF-3. FIG. 8B is an enlarged plan view of section BB of FIG. 8A, at which an opening OP provided in plural (e.g., a plurality of openings OP) are provided.

Referring to FIGS. 8A and 8B, the protective film PF-3 may have one or more openings OP defined in a third portion PT3-1 of a first region AR1-2. In an embodiment, at least one of the plurality of openings OP has a rectangular shape overall. At least one of the plurality of openings OP may form an obtuse angle with respect to the first direction DR1, without being limited thereto.

The opening OP which extends through a thickness of the protective film PF-3 may minimize friction and/or contact area between the protective film PF-3 and the heat radiation layer GR of the display module DM. In addition, the opening OP may reduce stress applied to the protective film PF-3 which occurs due to variation in film removal direction and/or film contact area, and thus may reduce or effectively prevent damage to the heat radiation layer GR and/or the protective film PF-3.

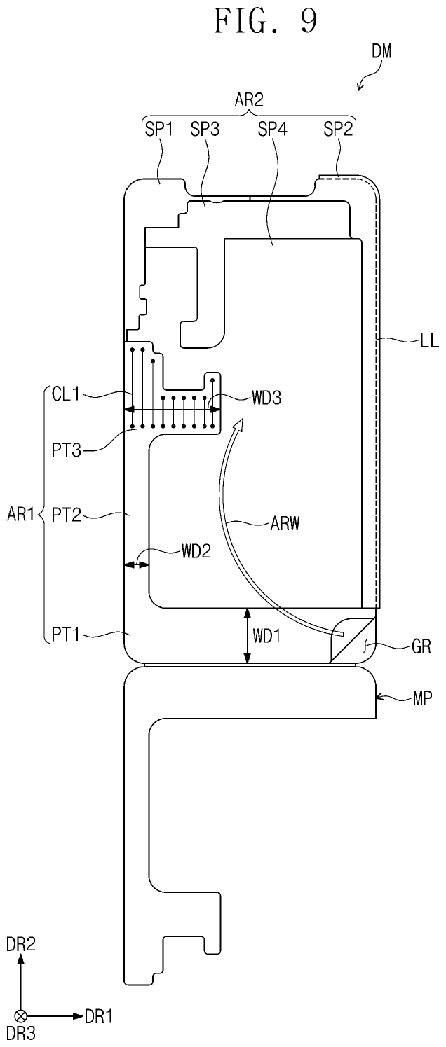

FIG. 9 shows an embodiment of a process in which the first region AR1 of a protective film PF is removed in a method of fabricating the display module DM.

Referring to FIGS. 1-3 and 9, the protective film PF may be removably attached to the display module DM, including the heat radiation layer GR. The first region AR1 of the protective film PF may have a planar shape corresponding to that of the flexible printed circuit board MP.

Referring to FIG. 9, the first portion PT1, the second portion PT2, and the third portion PT3 may be sequentially detached in order along a direction denoted by an arrow ARW, and accordingly the first region AR1 of the protective film PF may be removed from the display module DM. The removing of the first region AR1 may dispose a portion of the heat radiation layer GR exposed to outside the display module DM.

A planar area or a dimension of the third portion PT3 may be larger than a planar area of second portion PT2 which precedes the third portion PT3 in the removal order described above. In an embodiment, the first width WD1, the second width WD2 and the third width WD3 may be defined in a direction crossing the relatively removal direction indicated by the arrow ARW. Referring to FIG. 9, for example, the arrow ARW indicates removal directions of the second portion PT2 and the third portion PT3 each along the second direction DR2, while the second width WD2 and the third width WD3 are each taken along the first direction DR1 which crosses the second direction DR2.

The plurality of first cutting lines CL1 defined in the third portion PT3 may minimize friction and/or contact area between the protective film PF and the heat radiation layer GR. In addition, the plurality of first cutting lines CL1 defined in the third portion PT3 may minimize friction between the protective film PF and the heat radiation layer GR which occurs due to variation in film removal direction or film contact area. Therefore, damage to the heat radiation layer GR may be reduced or effectively prevented. After the removal of the first region AR1 of the protective film PF, a portion of the heat radiation layer GR which is exposed to outside the display module DM may have a planar shape corresponding to that of the flexible printed circuit board MP.

One or more embodiment of a protective film PF may include a plurality of cutting lines each having a cut shape relative to a thickness of the protective film PF.

One or more embodiment of a method of fabricating a display module may reduce or effectively prevent damage to a heat radiation layer GR of the display module DM to which the protective film PF is attached, in a process in which a portion of the protective film PF removably attached to the heat radiation layer GR is removed.

Although the invention is described in conjunction with embodiments thereof, it would be understood by those skilled in the art that the invention can be modified or changed in various ways without departing from spirit and scope of the invention defined by the appended claims. Further, the embodiments disclosed herein are not intended to limit the technical spirit of the invention, and all technical spirit within the claims and their equivalents should be construed as being included in the invention.

What is claimed is:

1. A protective film, comprising:
a film layer which is removably attachable to a display module; and
a film adhesive layer which removably attaches the film layer to the display module,
wherein
the film layer includes a first region having a shape corresponding to less than a total shape of the display module, the first region including:
a first portion extending along a first direction and having a first width along a second direction crossing the first direction;
a second portion extending along the second direction, from the first portion, and having a second width along the first direction; and
a third portion extending along the second direction, from the second portion having the second width, and having a third width along the first direction which is greater than the second width,
detachment of the film layer from the display module includes the third portion detached after the second portion, and
the third portion which has the third width greater than the second width and is detached after the second portion includes a plurality of first cuts extended into a thickness of the film layer.

2. The protective film of claim 1, wherein at least one of the plurality of first cuts is defined by:
a first segment having a first curvature;
a second segment having a second curvature; and
a third segment which is linear and connects the first segment to the second segment.

3. The protective film of claim 1, wherein the plurality of first cuts extend inclined with respect to the first direction.

4. The protective film of claim 1, wherein the first width of the first portion of the film layer is greater than the second width of the second portion of the film layer.

5. The protective film of claim 1, wherein
the film layer further includes a second region having a shape corresponding to a shape of the display module excluding the shape of the first region,
the second region of the film layer is separable from the first region thereof and includes a plurality of sub-regions separable from each other, and
the plurality of sub-regions include:
a first sub-region and a second sub-region spaced apart from each other and corresponding to opposing outer edges of the display module, and
a third sub-region between the first sub-region and the second sub-region.

6. The protective film of claim 5, wherein the third sub-region between the first sub-region and the second sub-region includes a plurality of second cuts extended into the thickness of the film layer.

7. The protective film of claim 1, wherein the film layer includes polyethylene terephthalate.

8. The protective film of claim 1, wherein the film adhesive layer includes silicon.

9. The protective film of claim 1, wherein a thickness of the film layer is in a range between about 54 micrometers and about 72 micrometers.

10. The protective film of claim 1, wherein a thickness of the film adhesive layer is in a range between about 5 micrometers and about 8 micrometers.

11. The protective film of claim 1, wherein
the first region of the film layer further includes a protrusion extending in the first direction from the first portion, and
attachment of the film layer to the display module disposes the protrusion of the first region extending further than an outer edge of the display module.

12. A protective film, comprising:
a film layer which is removably attachable to a display module; and
a film adhesive layer which removably attaches the film layer to the display module,
wherein
the film layer includes a first region having a shape corresponding to less than a total shape of the display module, the first region including:
a first portion extending along a first direction and having a first width along a second direction crossing the first direction;
a second portion extending along the second direction, from the first portion, and having a second width along the first direction; and
a third portion extending along the second direction, from the second portion having the second width, and having a third width along the first direction which is greater than the second width,
detachment of the film layer from the display module includes the third portion detached after the second portion, and
the third portion which has the third width greater than the second width and is detached after the second portion includes a plurality of openings extended through a thickness of the film layer.

13. The protective film of claim 12, wherein
at least one of the plurality of openings has a rectangular shape, and
at least one of the plurality of openings forms an obtuse angle with respect to the first direction.

14. The protective film of claim 12, wherein the first width of the first portion of the film layer is greater than the second width of the second portion of the film layer.

15. The protective film of claim 12, wherein
the film layer further includes a second region having a shape corresponding to a shape of the display module excluding the shape of the first region,
the second region of the film layer is separable from the first region thereof and includes a plurality of sub-regions separable from each other, and
the plurality of sub-regions include:
a first sub-region and a second sub-region spaced apart from each other and corresponding to opposing outer edges of the display module, and
a third sub-region between the first sub-region and the second sub-region, the third sub-region between the first sub-region and the second sub-region including a plurality of cuts extended into the thickness of the film layer.

16. The protective film of claim 12, wherein
the film layer includes polyethylene terephthalate, and
a thickness of the film layer is in a range between about 54 micrometers and about 72 micrometers.

17. The protective film of claim 12, wherein
the film adhesive layer includes silicon, and
a thickness of the film adhesive layer is in a range between about 5 micrometers and about 8 micrometers.

18. A method of providing a display module, the method comprising:
providing the display module including a display panel, a heat radiation layer defining a rear surface of the display module, and a flexible printed circuit board connected to the display panel and disposable adjacent to the rear surface of the display module;
providing a protective film removably attached to the heat radiation layer, the protective film including a first region having a shape corresponding to a shape of the flexible printed circuit board, wherein the first region includes:
a second portion having a second width along a first direction; and
a third portion extending along a second direction which crosses the first direction, from the second portion having the second width, the third portion having a third width along the first direction which is greater than the second width; and
sequentially detaching the second portion and the third portion of the protective film from the heat radiation layer,
wherein the third portion of the protective film which has the third width greater than the second width and is sequentially detached from the heat radiation layer after the second portion includes a plurality of first cuts extended into a thickness of the protective film.

19. The method of claim 18, wherein at least one of the plurality of first cuts includes:
a first segment having a first curvature;
a second segment having a second curvature; and
a third segment which is linear and connects the first segment to the second segment.

20. The method of claim 18, wherein
the protective film further includes a second region having a shape corresponding to a shape of the display module excluding the shape of the flexible printed circuit board,
the second region of the protective film is separable from the first region thereof and includes a plurality of sub-regions separable from each other, and
the plurality of sub-regions include:
a first sub-region and a second sub-region spaced apart from each other and corresponding to opposing outer edges of the display module, and
a third sub-region between the first sub-region and the second sub-region,
wherein the third sub-region includes a plurality of second cuts extended into the thickness of the protective film.
